(19) United States
(12) Patent Application Publication
(10) Pub. No.: US 2009/0244470 A1
(43) Pub. Date: Oct. 1, 2009

(54) Liquid crystal display device

(75) Inventor: Hiroshi Yamate, Mobara (JP)

Correspondence Address: Juan Carlos A. Marquez;c/o Stites & Harbison PLLC, 1199 North Fairfax Street, Suite 900, Alexandria, VA, 22314-1437, US

(73) Assignee: Hitachi Display, Ltd.

(21) Appl. No.: 12/382,786

(22) Filed: Mar. 24, 2009

(30) Foreign Application Priority Data
Mar. 25, 2008 (JP) 2008-078132

(51) Int. Cl. G02F 1/1345

(52) U.S. Cl. 349/150

(57) ABSTRACT

A liquid crystal shutter (50) is provided behind a liquid crystal display panel, and a light source accommodated in a lower mold (65) is provided behind the liquid crystal shutter (50). As a liquid crystal display panel flexible cable (15) and a liquid crystal shutter flexible cable (80) are placed close to each other, and connected to the same printed circuit board (75), the number of printed circuit boards (75) is able to be saved to one, as well as the number of connecters (76) for connecting the printed circuit board (75) to the outside.

### CROSS-REFERENCE TO RELATED APPLICATION

The present application claims priority from Japanese Application JP2008-078132 filed on Mar. 25, 2008, the content of which is hereby incorporated by reference into this application.

### BACKGROUND OF THE INVENTION

1. Field of the Invention

The present invention relates to a display device, and more particularly to a liquid crystal display device having a plurality of liquid crystal cells stacked on in a direction perpendicular to the display surface.

2. Description of the Related Art

There is an increasing demand for a liquid crystal display device for use with a computer display, a portable phone terminal, a television, and the like. When a liquid crystal display device outputs a normal liquid crystal display image, an image with high visibility irrespective of a direction from which to see is required. Meanwhile, when a specific image for, e.g., password input or the like, is shown on a liquid crystal display device used in, e.g., an automated teller machine terminal, the specific image is desired to be not readily seen from a diagonal direction so as to prevent the image from being cheated by a third party. In view of the above, there is a need of considering a liquid crystal display device capable of electrically switching the modes between a mode with high visibility ensured irrespective of a viewing angle and a mode with high visibility constantly ensured when viewed from the substantially front direction thereof but poor visibility when viewed from a diagonal direction in which only an image not clearly seen is provided.

A technique for switching images, using a liquid crystal shutter is disclosed in, e.g., Japanese Patent Laid-open Publication No. 2007-7315.

### SUMMARY OF THE INVENTION

As one example of a structure capable of switching the visibility when a liquid crystal display device is viewed from a diagonal direction, there is available a liquid crystal display having two liquid crystal cells stacked one on the other with respect to a liquid crystal display surface, in which a liquid crystal cell capable of controlling the direction in which backlight light proceeds is provided behind a liquid crystal cell for displaying an image and ahead of the backlight. Note that, in this specification, the liquid crystal cell for displaying an image is referred to as a liquid crystal display panel, and the liquid crystal cell capable of electrically controlling the scattering characteristic is referred to as a liquid crystal shutter. The liquid crystal shutter can be realized using a liquid crystal cell with polymer-network type liquid crystal or the like enclosed therein. Practical use of such a liquid crystal shutter is promoted, including application to window glass by, e.g., providing a liquid crystal shutter at the middle of window glass, in which the liquid crystal shutter normally remains as camphor glass and, with electricity applied thereto, turns to be transparent in appearance.

To display a normal liquid crystal image on a liquid crystal display device having the above-described device, backlight light with high directivity is scattered due to scattering characteristic of the liquid crystal shutter before being input to the liquid crystal cell closer to a viewer, which results in less viewing angle dependency with respect to brightness. Meanwhile, to display a specific image with high visibility when viewed from the front direction but poor visibility when viewed from a diagonal direction, a voltage is applied to the liquid crystal shutter provided behind the liquid crystal display panel, upon which the scattering characteristic of the liquid crystal shutter is eliminated and the liquid crystal shutter becomes transparent in appearance. With the liquid crystal shutter being transparent, light with strong directivity from a light source is not scattered before being input to the liquid crystal panel, and resultantly, a liquid crystal image with strong directivity is displayed. When strong forward directivity from the backlight is set, a third party looking at the liquid crystal display image from a direction other than the front direction will see only a hardly visible dark image.

To display an image on a liquid crystal display panel, a scanning signal, an image signal, power, and the like need to be constantly supplied to the liquid crystal display panel via a liquid crystal display panel flexible cable connected to a terminal of the liquid crystal display panel. Further, to display a normal image in the liquid crystal display device, light from a CCFL is scattered by the liquid crystal shutter, utilizing characteristic thereof to scatter passing light, to thereby enhance visibility when viewed from a diagonal direction. Meanwhile, to display an image which is desired to be seen only from the front direction on the liquid crystal display panel, electricity is applied to the liquid crystal shutter, and the liquid crystal shutter becomes transparent in appearance. In the above, an electric signal needs to be supplied also to the liquid crystal shutter side.

Therefore, in a liquid crystal display device capable of displaying a normal image and a specific image on a liquid crystal display panel, each of the two liquid crystal panels needs a power supply and signal supply, and the like. This results in complicated wiring and increased manufacturing cost.

The present invention aims to solve the above described problem, and a specific structure as described below will be employed.

(1) In order to solve the above-described problem, according to one aspect of the present invention, there is provided a liquid crystal display device in which a plurality of liquid crystal cells are stacked in a direction perpendicular to a display surface, in which flexible cables are connected to each of the liquid crystal cells, and the respective flexible cables are connected to a same printed circuit board mounted on a lateral surface of the liquid crystal display device.
(2) In the above described liquid crystal display device, an interval between the flexible cables may be smaller than a half of a longer side of the lateral surface of the liquid crystal display device such that the flexible cables are located close to each other.
(3) In the above described liquid crystal display device, the flexible cables may not overlap each other on the printed circuit board.

In one embodiment of the present invention, as the flexible cable from the liquid crystal display panel and that from the liquid crystal shutter are connected to the same printed circuit board, it is possible to reduce the material cost of a printed circuit board and a connecter for use in connection from the printed circuit board to an external circuit. Further, as the number of steps of assembling the liquid crystal display device can be reduced, the manufacturing cost of the liquid crystal display device can be reduced.

In another embodiment of the present invention, a smaller interval is defined between the flexible cable from the liquid crystal display panel and that from the liquid crystal shutter, the two flexible cables can be readily connected to the same printed circuit board and also the size of the printed circuit board can be made smaller. Therefore, reduction of the material cost of and the number of steps of assembling the liquid crystal display device can be reduced, which can reduce the cost of the liquid crystal display device.

### BRIEF DESCRIPTION OF THE DRAWINGS

FIG. 1 is a cross sectional view of a liquid crystal display device according to an embodiment of the present invention;

FIG. 2 is an exploded perspective view of the liquid crystal display device according to the embodiment of the present invention;

FIG. 3 is a major element perspective view of the liquid crystal display device according to the embodiment of the present invention;

FIG. 4 is a schematic plan view of the liquid crystal display device according to the embodiment of the present invention;

FIG. 5 is a diagram showing the liquid crystal display device according to the embodiment of the present invention in which a light source is provided;

FIG. 6A is a diagram illustrating the principle of operation of a liquid crystal shutter;

FIG. 6B is a diagram illustrating the principle of operation of the liquid crystal shutter;

FIG. 7 is a plan view of the liquid crystal shutter; and

FIG. 8 is a perspective view schematically showing a conventional liquid crystal display device.

### DETAILED DESCRIPTION OF THE INVENTION

An embodiment of the present invention will be described in the following.

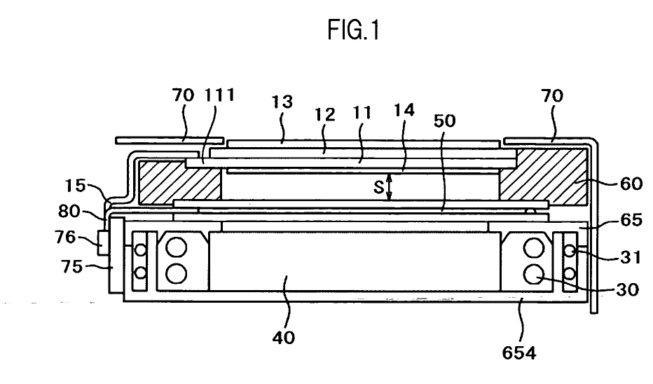

FIG. 1 is a schematic cross sectional view of a liquid crystal display device according to an embodiment of the present invention. In FIG. 1, a liquid crystal display panel is mounted on an upper mold 60. The liquid crystal display panel comprises a TFT substrate 11 where a pixel electrode, a TFT, and the like are formed, and an opposed substrate 12 where a color filter and the like is formed, with liquid crystal enclosed between the TFT substrate 11 and the opposed substrate 12. A lower polarizer 14 is attached on the lower surface of the TFT substrate 11, and an upper polarizer 13 is attached on the upper surface of the opposed substrate 12.

The TFT substrate 11 is slightly larger in size than the opposed substrate 12. A terminal 111 via which to supply power, a signal, and so forth to the liquid crystal panel is formed where the TFT substrate 11 remains alone. And the flexible cable 15 for the liquid crystal display panel is connected to the terminal 111. The liquid crystal display panel flexible cable 15 runs on the upper surface of the upper mold 60, and bends along the lateral surface of the upper mold 60 to be connected to a PCB 75 (a printed circuit board) mounted on the lateral surface of the lower mold 65. A flexible cable 80 extending from the liquid crystal shutter 50 is also connected to the PCB 75, as will be described later.

On the back side of the liquid crystal display panel, a liquid crystal shutter 50 is provided on the lower mold 65 such that a space S is ensured between the liquid crystal display panel and the liquid crystal shutter 50. The width of the space S is, e.g., about 1 mm, the width corresponding to the length within the range indicated by the arrow in the drawing and being defined by the upper mold 60.

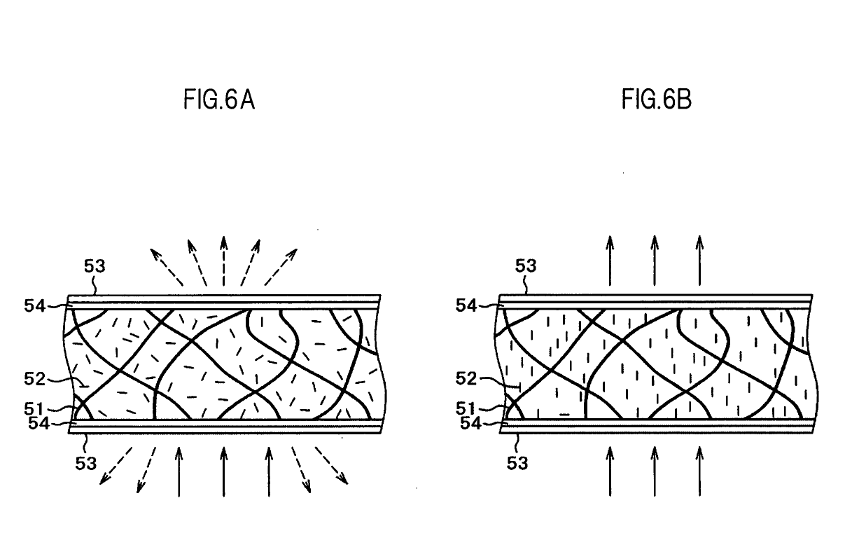

FIGS. 6A and 6B illustrate the principle of operation of the polymer network liquid crystal shutter (PNLC) 50. In FIGS. 6A and 6B, with a voltage applied to the liquid crystal shutter 50, light passes through the PNLC 50, almost not being scattered, and with voltage application stopped, light proceeds in random directions, while being scattered. FIG. 6A is a schematic cross sectional view of the liquid crystal shutter 50 with no voltage applied. As shown in FIG. 6A, liquid crystal is enclosed between two plastic substrates 53, and high polymer 51 formed like a network is enclosed between the two plastic substrates 53 with liquid crystal molecules 52 irregularly aligned therein.

In the state shown in FIG. 6 A, irregularly aligned liquid crystal molecules 52 scatter light, as a result of which the liquid crystal shutter 50 turns to be opaque. The liquid crystal shutter 50 in such a state functions as a sort of a scattering panel. Note that a transparent electrode 54 made of ITO or the like is formed on the side of the plastic substrate 53, which faces the liquid crystal.

In the state shown in FIG. 6A, light from a backlight provided on the back side of the liquid crystal display device is scattered by the liquid crystal shutter 50 before being input into the liquid crystal display panel located ahead of the liquid crystal shutter 50. As a result, brightness of the display screen when viewed in a diagonal direction does not drop remarkably, compared to that when viewed from the directly front of the display screen. That is, with no voltage applied to the liquid crystal shutter 50, an image less dependent on a viewing angle is shown on the liquid crystal display device shown in FIG. 1.

FIG. 6B shows a state with a voltage applied to the transparent electrodes 54 formed inside between the plastic substrates 53. Specifically, with a voltage applied to between the upper and lower transparent electrodes 54, the liquid crystal molecules 52 are aligned in the up-down direction, as shown in FIG. 6B, as a result of which the liquid crystal shutter 50 passes light.

In the state in which a voltage is applied to the liquid crystal shutter 50 and light passes through the liquid crystal shutter 50, the liquid crystal shutter 50 becomes substantially transparent, and an image highly dependent on a viewing angle in accordance with the directivity of the light output from the backlight is shown in the liquid crystal display device shown in FIG. 1.

With the liquid crystal shutter 50 shown in FIG. 6 being turned on, a pulse voltage being switched between positive and negative in the order of msec is applied to between the upper and lower transparent electrodes 54. Meanwhile, with the liquid crystal shutter 50 being turned off and thus no voltage being applied to the liquid crystal shutter 50, the liquid crystal molecules are directed random, and the light is scattered.

For application of a voltage into between the upper and lower transparent electrodes 54 of the liquid crystal shutter 50, the flexible cable 80 is connected to the upper and lower transparent electrodes 54 of the liquid crystal shutter 50, and extends outside the liquid crystal display device.

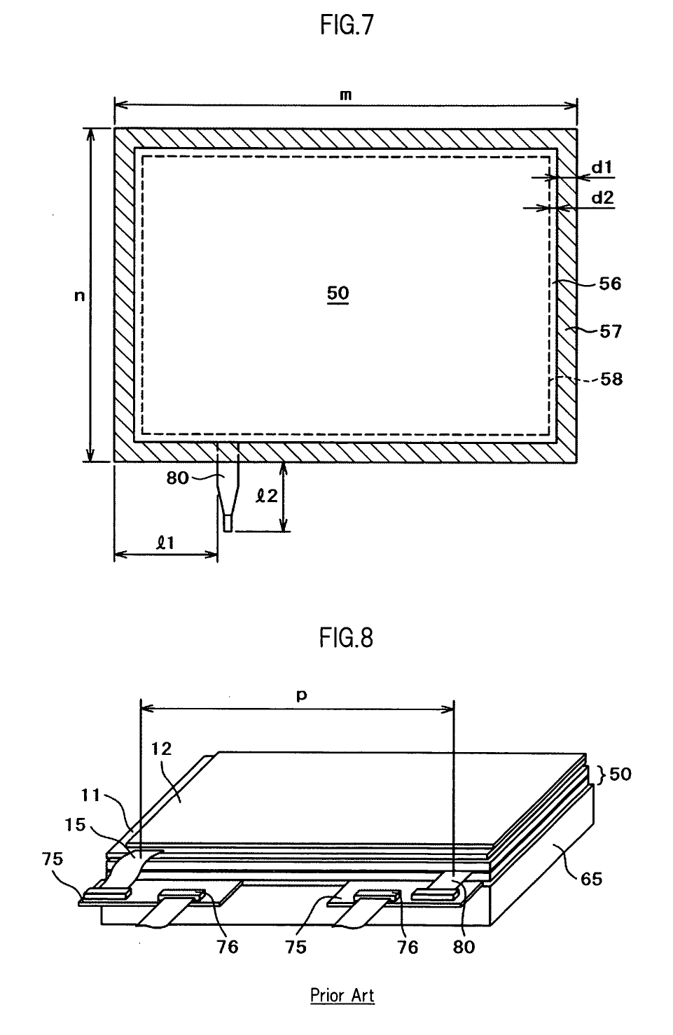

FIG. 7 is a plan view of the liquid crystal shutter 50, in which the area enclosed by the dot line corresponds to an area where the liquid crystal shutter 50 passes or scatters light. This area is hereinafter referred to as a transmitting area 58. Specifically, the transmitting area 58 corresponds to the display area of the liquid crystal display panel. The liquid crystal shutter 50 has a longer side m and a shorter side n, and the external size of the longer side m is 278 mm, while that of the shorter side n is 173 mm. As shown in FIG. 7, the plastic substrates 53 of the liquid crystal shutter 50 are closely attached to each other by a sealing member 56 in an area around the transmitting area 58, the sealing member 56 having the width d2 of 1.0 mm.

In FIG. 7, the plastic substrate 53 projects from the sealing area with the sealing member 56 to outside, thereby constituting a projected area 57 having the width d1 of about 3 mm. And the flexile cable 80, electrically connected to the upper and lower transparent electrodes 54 of the liquid crystal shutter 50, is installed on the projected area 57. The flexible cable 80 is also connected to the PCB 75, made of glass epoxy or the like and provided on the lateral surface of the lower mold 65, as will be described later. For this purpose, the flexible cable 80 is relatively long, specifically, having the length 12 being about 23 mm in FIG. 7. The flexible cable 80 has a terminal at the tip end thereof for connection to the PCB 75.

In this embodiment, the flexible cable 80 is connected in a position closer to an end from the middle of the longer side. Specifically, the distance from the shorter side to the flexible cable 80 along the longer side is, e.g., about 74 mm. Meanwhile, the flexible cable 15 (not shown in FIG. 7) extending from the liquid crystal display panel runs along the lateral surface of the upper mold 60 and is connected to the PCB 75, provided on the lateral surface of the lower mold 65. As the flexible cable 80 from the liquid crystal shutter 50 is connected in a position closer to the shorter side, the flexible cable 80 from the liquid crystal shutter 50 and the flexible cable 15 from the liquid crystal display panel are resultantly located close to each other, which makes it relatively easy to connect the flexible cable 80 and the flexible cable 15 to the same PCB 75 at the same time. Obviously, however, the position of the flexible cable 80 of the liquid crystal shutter 50 is not limited to the above described position.

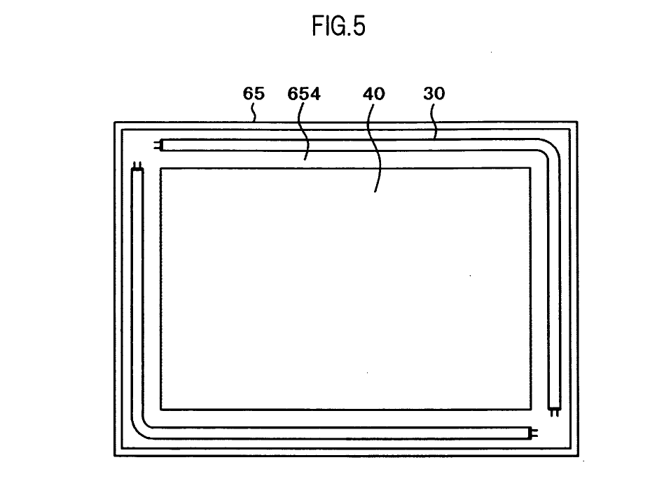

Returning to FIG. 1, the liquid crystal shutter 50 is fixedly mounted between the upper mold 60 and the lower mold 65 where a CCFL 30 (a cold cathode fluorescent lamp) as a light source is provided. The light source CCFL 30 is provided on the lateral surfaces constituting the inner circumferential surface of the lower mold 65. In this embodiment, as shown in FIG. 5, two L-shaped CCFL's 30 are provided along the lateral surfaces constituting the inner circumference of the lower mold 65 such that the light source is provided along the inner circumference of the lower mold 65.

In FIG. 5, the CCFL 30 is provided on the lower frame 654 of the lower mold 65. In addition, a light guide panel 40 for enhancing directivity in the front direction of the liquid crystal display panel is provided on the inner surface of the lower frame 654 of the lower mold 65. The light source is provided in two stories, as shown in FIG. 1, thereby enhancing brightness. That is, in this embodiment, four L-shaped CCFL's are used as the light source. A cable 31 for the CCFL 30 is accommodated in a recess formed outside the lower mold 65.

In FIG. 1, the lateral surface of the lower mold 65 is covered by the upper frame 70. The PCB 75 is formed on a part of the lateral surface of the lower mold 65, and the liquid crystal display panel flexible cable 15 extending from the liquid crystal display panel and the liquid crystal shutter flexible cable 80 extending from the liquid crystal shutter 50 are connected to the PCB 75. In this embodiment, the liquid crystal display panel flexible cable 15 and the liquid crystal shutter flexible cable 80 are both connected to the same PCB 75.

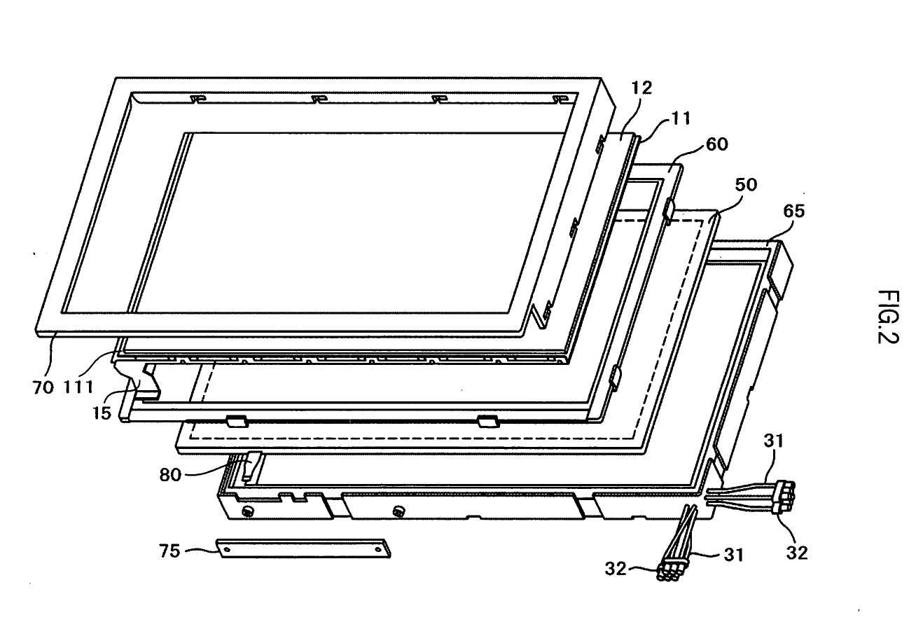

FIG. 2 is an exploded perspective view of the liquid crystal display device according to this embodiment. As shown in FIG. 2, the peripheral portion of the liquid crystal display panel excluding the display area is covered by a protective upper frame 70 made of metal, such as Al or the like. While the upper frame 70 covers the substantially entire lateral surface of the liquid crystal display device, there is formed a cut-off on the longer side of the upper frame 70 so that the PCB 75 is mounted so as to expose from the cut-off. As shown in FIG. 2, the upper frame 70 covers the lateral surface except for the lateral surface attached the PCB 75, in this embodiment.

As described with reference to FIG. 1, the TFT substrate 11 where a pixel electrode, a TFT, and the like are formed is slightly larger than the opposed substrate 12 where a color filter or the like is formed, and the terminal 111 is formed on the peripheral portion of the TFT substrate 11. The liquid crystal display panel flexible cable 15 is connected to the terminal 111. The liquid crystal display panel flexible cable 15 runs on the upper and lateral surfaces of the upper mold 60 and is connected to the PCB 75 provided on the lateral surface of the lower mold 65. As shown in FIG. 2, the liquid crystal display panel flexible cable 15 is connected in a position close to an end of the longer side of the liquid crystal display panel. This arrangement is made, as will be described later, for the purpose of saving the number of PCB 75 to one and also to reduce the size of the PCB by connecting the flexible cable 15 to the PCB 75 in a position close to the flexible cable 80 from the liquid crystal shutter 50.

The liquid crystal display panel is mounted on the upper mold 60. A concave is formed on the inner circumference of the upper mold 60, into which the liquid crystal display panel is fit. The liquid crystal shutter 50 is provided under the upper mold 60. The liquid crystal shutter flexible cable 80 is connected to the longer side of the liquid crystal shutter 50. Specifically, the liquid crystal shutter flexible cable 80 is connected to a position on the longer side of the liquid crystal shutter 50 in the vicinity (at an end of the longer side) of the shorter side which forms a vertex together with the longer side, the position for avoiding overlapping with the liquid crystal display panel flexible cable 15.

The lower mold 65 is provided on the rear surface of the liquid crystal shutter 50. The CCFL 30 is provided on the lateral surface forming the inner circumference of the lower mold 65, as shown in FIG. 5. The cable 31 for the CCFL 30 extends outside the lower mold 65, as shown in FIG. 2, being collected at a corner of the lower mold 65. As four CCFL's 30 are used, four CCFL connecters 32 are used.

In FIG. 2, in order to save the space for the liquid crystal display device, the PCB 75 where circuits for driving the liquid crystal display panel and the liquid crystal shutter 50 are formed is provided on the lateral surface of the lower mold 65. In this embodiment, the liquid crystal display panel flexible cable 15 and the liquid crystal shutter flexible cable 80 are connected to the same PCB 75. In addition, the liquid crystal display panel flexible cable 15 and the liquid crystal shutter flexible cable 80 are provided close to each other, which makes it possible to form a compact PCB 75. The smaller the PCB 75 is, the larger the advantage in terms of space and cost becomes.

FIG. 8 is a schematic diagram of a conventional liquid crystal display device, in which the upper mold 60 or the like is not shown. In FIG. 8, the liquid crystal display panel is mounted on the liquid crystal shutter 50. For the liquid crystal display panel, the opposed substrate 12, slightly smaller in size than the TFT substrate 11, is placed on the TFT substrate 11. The liquid crystal display panel flexible cable 15 is connected at an end of the longer side of the liquid crystal display panel. A liquid crystal shutter 50 is placed behind the liquid crystal display panel, specifically, mounted on the lower mold 65.

The liquid crystal shutter flexible cable 80 is connected to the longer side of the liquid crystal shutter 50, specifically, to an end of the longer side of the liquid crystal display panel, opposite the end thereof to which the liquid crystal display panel flexible cable 15 is connected. In FIG. 8, the interval p between the two flexible cables is larger than a half of the longer side of the liquid crystal display panel. Conventionally, two PCB's 75, namely a PCB 75 for a liquid crystal display panel and a PCB 75 for the liquid crystal shutter 50, are used, as shown in FIG. 8.

In the conventional liquid crystal display device shown in FIG. 8, as the liquid crystal shutter 50 requires a unique driving circuit, a PCB 75 separately from the PCB 75 for liquid crystal display panel is used. However, use of two PCB's 75 is disadvantageous in terms of component material cost of the PCB 75. Moreover, as the PCB 75 needs to be connected to an external circuit, each PCB 75 needs a connecter 76 for connection to the external circuit. Further, presence of two PCB's 75 results in increase of the number of steps of assembling the liquid crystal display device, which is disadvantageous in terms of cost.

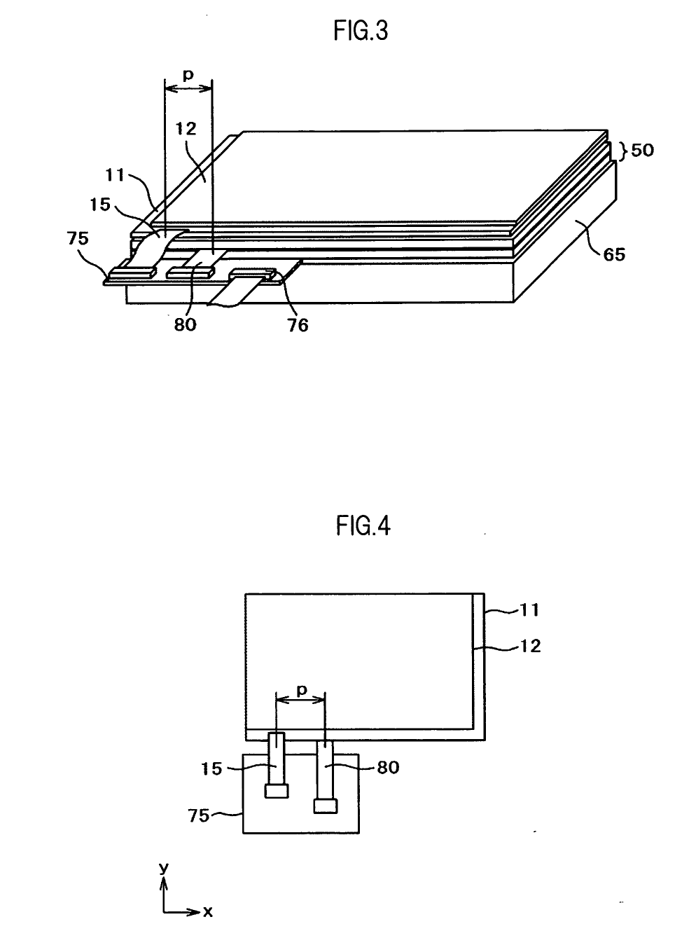

FIG. 3 is a diagram corresponding to FIG. 8 and showing a structure of the liquid crystal display device according to the present invention, in which the upper mold 60 or the like is not shown. The structure shown in FIG. 3 significantly differs from the conventional structure shown in FIG. 8 in that the position in which the liquid crystal shutter flexible cable 80 is connected to the liquid crystal shutter 50 is present on the longer side of the liquid crystal shutter 50, which is close to the position of the liquid crystal display panel flexible cable 15. When the liquid crystal display panel flexible cable 15 is located close to the liquid crystal shutter flexible cable 80, two flexible cables can be connected to the same substrate without enlarging the PCB 75. As shown in FIG. 3, by connecting the liquid crystal display panel flexible cable 15 and the liquid crystal shutter flexible cable 80 to the same PCB 75, the number of connecters 76 required for connection from the PCB 75 to an external circuit can be reduced to one.

FIG. 4 is a schematic plan view corresponding to FIG. 3. As shown in FIG. 4, the liquid crystal display panel flexible cable 15 is connected to an end of the TFT substrate 11, and the liquid crystal shutter flexible cable 80 is connected to the liquid crystal shutter (not shown) provided behind the liquid crystal display panel. The external shape of the liquid crystal display panel is substantially identical to that of the liquid crystal shutter 50 shown in FIG. 7. In FIG. 4, the liquid crystal display panel flexible cable 15 is connected to a position close to an end of the longer side of the liquid crystal display panel. In addition, the liquid crystal shutter flexible cable 80 is connected to a position close to the end of the longer side of the liquid crystal shutter 50 (not shown). The two flexible cables are connected to the same PCB 75. In FIG. 4, two flexible cables are positioned not overlapping with each other to ensure better operability in connecting the flexible cable to the PCB 75.

In FIG. 4, the interval p between the liquid crystal display panel flexible cable 15 and the liquid crystal shutter flexible cable 80 is desired to be smaller than m/2, or a half of the longer side of the liquid crystal shutter 50, in order to form a compact PCB 75. Such a structure can ensure a PCB 75 having a longer side equal to or shorter than a half of the longer side of the liquid crystal display panel, as shown in FIG. 2 or 4. Further, the interval p between the liquid crystal display panel flexible cable 15 and the liquid crystal shutter flexible cable 80 is desired to be set such that the two flexible cables do not overlap with each other in order to facilitate operation for connection between the flexible cable and the PCB 75. Note that although it is described in the above that the interval p is desired to be smaller than a half of the longer side of the liquid crystal shutter 50, obviously, a half of the longer side of the liquid crystal display panel or the longitudinal size on the lateral surface of the liquid crystal display device may be used as a reference.

In FIG. 4, two flexible cables are provided on the left half of the longer side of the liquid crystal display panel and the left half of the longer side of the liquid crystal shutter 50 corresponding to that longer side. Alternatively, the two flexible cables may be provided on the right half or at the middle of the longer side of the liquid crystal display panel and the like. That is, where to provide the flexible cables may be determined in consideration of requirement of the entire liquid crystal display device. In any case, provision of two flexible cables close to each other enables reduction of the size of the PCB 75.

Meanwhile, for a PCB 75 having a larger circuit, the longer side of the PCB 75 may not be suppressed to a half of the longer side of the liquid crystal display panel. In such a case, the interval between the two flexible cables is not necessarily limited to a half of the longer side of the liquid crystal display panel. However, in this case as well, use of a single PCB 75 makes it possible to reduce material cost and the number of assembling steps.

Note that although the liquid crystal display panel flexible cable 15 is provided closer to outside (closer to the vertex) than the liquid crystal shutter flexible cable 80 is in FIG. 4, this is not an exclusion example. Instead, the liquid crystal shutter flexible cable 80 may be provided closer to outside than the liquid crystal display panel flexible cable 15 is. In addition, although the liquid crystal shutter flexible cable 80 on the PCB 75 is longer than the liquid crystal display panel flexible cable 15 in FIG. 4, this is not an exclusive size. Instead, the flexible cable 80 on the PCB 75 may have an identical length to or may be slightly shorter than that of the flexible cable 15.

As described above, according to the present invention, as circuits for driving the liquid crystal display panel and the liquid crystal shutter 50 are formed on the same PCB 75, the number of PCB's 75 and that of the connecters 76 for connecting the PCB 75 and an external circuit can be reduced. Moreover, the number of steps for the connection can be reduced, which can remarkably reduce the cost of the liquid crystal display device. While there have been described what are at present considered to be certain embodiments of the invention, it will be understood that various modifications may be made thereto, and it is intended that the appended claims cover all such modifications as fall within the true spirit and scope of the invention.

What is claimed is:

1. A liquid crystal display device in which a plurality of liquid crystal cells are stacked in a direction perpendicular to a display surface, in which flexible cables are connected to each of the liquid crystal cells, and the respective flexible cables are connected to a same printed circuit board mounted on a lateral surface of the liquid crystal display device.

2. The liquid crystal display device according to claim 1, wherein an interval between the flexible cables is smaller than a half of a longer side of the lateral surface of the liquid crystal display device such that the flexible cables are located close to each other.

3. The liquid crystal display device according to claim 1, wherein the flexible cables do not overlap each other on the printed circuit board.
